(19) United States
(12) Patent Application Publication
(10) Pub. No.: US 2026/0184167 A1
(43) Pub. Date: Jul. 2, 2026

(54) VEHICLE SEAT

(71) Applicants: TS TECH CO., LTD., Saitama (JP); HONDA MOTOR CO., LTD., Tokyo (JP)

(72) Inventors: Hidetsune NONAKA, Tochigi-ken (JP); Yoshiaki ITO, Tochigi-ken (JP); Manabu MATSUMOTO, Tokyo (JP); Hinako YOKOYAMA, Tokyo (JP)

(21) Appl. No.: 19/433,206

(22) Filed: Dec. 26, 2025

(30) Foreign Application Priority Data
Dec. 26, 2024 (JP) 2024230704

(51) Int. Cl. B60K 35/22; B60N 2/68; B60R 13/02

(52) U.S. Cl. CPC B60K 35/223; B60N 2/68; B60R 13/02; B60K 2360/77

(57) ABSTRACT

A vehicle seat includes a seatback frame, a display device, and a cover member. The display device includes a coupling portion coupled to the seatback frame. The cover member is arranged to cover the coupling portion. The lower end of the cover member is arranged above the lower end of the display device.

### CROSS-REFERENCE TO RELATED APPLICATIONS

This application is based upon and claims the benefit of priority from Japanese Patent Application No. 2024-230704 filed on Dec. 26, 2024, the contents of which are incorporated herein by reference.

### BACKGROUND OF THE INVENTION

### Field of the Invention

The present disclosure relates to a vehicle seat.

### Description of the Related Art

JP 2017-210158 A discloses a vehicle seat equipped with a display unit at a rear portion of the seat. The vehicle seat includes a seatback and the display unit attached to a rear side of the seatback. The display unit is coupled to a back frame that is a framework of the seatback. The display unit is slidable in the up-down direction with respect to the seatback.

### SUMMARY OF THE INVENTION

In the above-described vehicle seat, a joint between a lower portion of the display unit and the back frame is covered with the seatback (upper backboard) so as not to be seen from an occupant on a rear seat. In such a configuration, there is a concern that the seatback is increased in size in order to cover the joint.

The present disclosure has the object of solving the aforementioned problem.

An aspect of the present disclosure is to provide a vehicle seat including: a seatback frame; a display device including a coupling portion to be coupled to the seatback frame and a monitor unit configured to display an image; and a cover member arranged to cover the coupling portion, wherein a lower end of the cover member is arranged above a lower end of the display device.

According to the present disclosure, the lower end of the cover member covering the coupling portion of the display device to be coupled to the seatback frame is positioned above the lower end of the display device. Therefore, an increase in size of the cover member can be effectively suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an external perspective view of a vehicle seat according to an embodiment of the present disclosure;

FIG. 2 is a partially enlarged rear view of the vehicle seat shown in FIG. 1;

FIG. 3 is a longitudinal cross-sectional view of the vehicle seat shown in FIG. 2;

FIG. 4 is a partially enlarged rear view of the vehicle seat, from which a display device is omitted;

FIG. 5 is an enlarged longitudinal sectional view of a coupling portion of a display device shown in FIG. 3 and its periphery;

FIG. 6 is a partially enlarged perspective view illustrating a rear side of the vehicle seat;

FIG. 7 is a first explanatory diagram relating to assembly of the display device;

FIG. 8 is a second explanatory diagram relating to the assembly of the display device; and

FIG. 9 is a third explanatory diagram relating to the assembly of the display device.

### DETAILED DESCRIPTION OF THE INVENTION

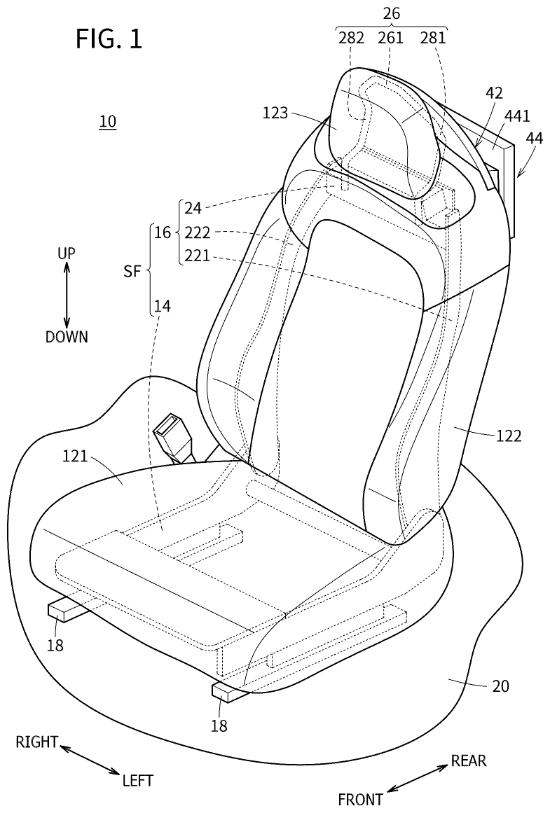

A vehicle seat 10 according to the present embodiment shown in FIG. 1 is installed in an automobile, a marine vessel, an aircraft, or the like. The vehicle seat 10 includes a seat cushion 121, a seatback 122 connected to the rear part of the seat cushion 121, and a headrest 123. An unillustrated occupant is to be seated on the seat cushion 121 of the vehicle seat 10. The seat cushion 121 includes a seat cushion frame 14. The seatback 122 includes a seatback frame 16. The seat cushion frame 14 and the seatback frame 16 constitute a seat frame SF. Hereinafter, the up-down direction and the front-rear direction of the seatback 122, the headrest 123, and the components thereof will be described with reference to a state in which the seatback 122 is not inclined in the front-rear direction with respect to the seat cushion 121 (the reclining angle is 0 degrees) as illustrated in FIG. 1. In the state in which the seatback 122 is not inclined in the front-rear direction, the headrest 123 is positioned substantially vertically over the seatback 122.

The seat cushion frame 14 is slidably installed on a floor surface 20 of the vehicle via rails 18.

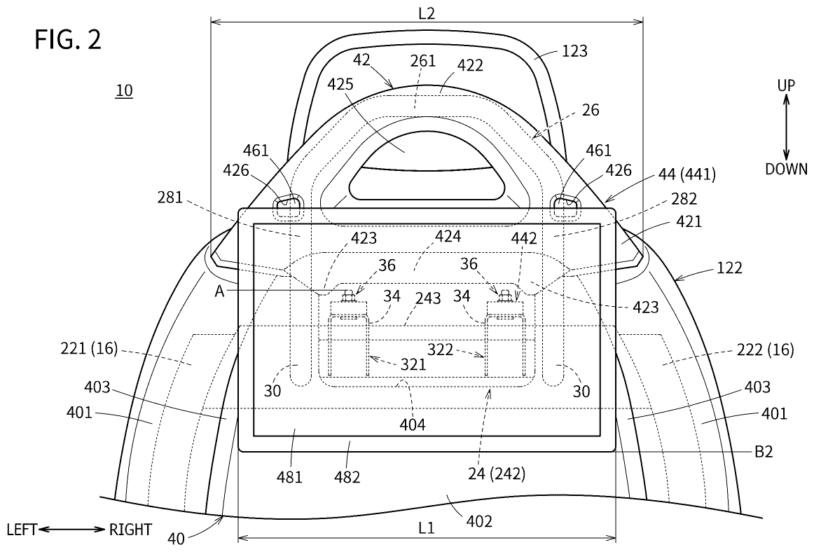

The seatback frame 16 includes a pair of frame bodies 221, 222 and a connecting frame 24. As shown in FIG. 2, the pair of frame bodies 221, 222 are separated from each other in a left-right direction of the vehicle seat 10 (hereinafter also referred to as a seat width direction) (see FIG. 2). The lower ends of the pair of frame bodies 221, 222 are joined to the seat cushion frame 14. The pair of frame bodies 221, 222 extend upward from the seat cushion frame 14.

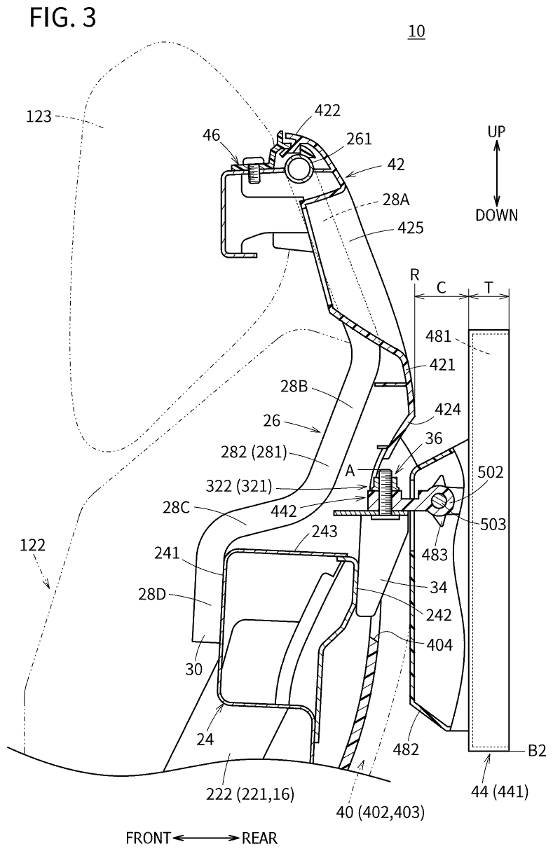

As shown in FIG. 2, the connecting frame 24 extends between the pair of frame bodies 221, 222 in the left-right direction. The connecting frame 24 connects the upper end portions of the pair of frame bodies 221, 222 to each other. As shown in FIG. 3, the connecting frame 24 is formed in a hollow shape having a substantially quadrangular cross section when viewed from the width direction of the vehicle seat 10.

The connecting frame 24 includes a front wall portion 241, a rear wall portion 242, and an upper wall portion 243. Each of the front wall portion 241 and the rear wall portion 242 has a surface extending in the up-down direction. The front wall portion 241 forms a front part of the connecting frame 24. The rear wall portion 242 is positioned rearward of and spaced apart from the front wall portion 241. The upper wall portion 243 is provided on the upper portions of the front wall portion 241 and the rear wall portion 242. The upper wall portion 243 connects the front wall portion 241 and the rear wall portion 242. The upper wall portion 243 extends in the left-right direction and is substantially orthogonal to the front wall portion 241 and the rear wall portion 242.

A headrest pillar 26 is connected to the connecting frame 24. As shown in FIG. 2, the headrest pillar 26 is formed in a U-shape that opens downward. The headrest pillar 26 extends upward from the connecting frame 24. The headrest pillar 26 includes an upper pillar portion 261 extending in the left-right direction, and a pair of leg portions 281, 282 extending downward from both ends of the upper pillar portion 261. The upper pillar portion 261 is positioned above the seatback 122. As shown in FIG. 3, the upper pillar portion 261 supports the headrest 123 of the vehicle seat 10.

As shown in FIG. 2, the pair of leg portions 281, 282 are provided at the ends of the upper pillar portion 261 in the width direction and are spaced apart from each other in the left-right direction. As shown in FIG. 3, each of the pair of leg portions 281, 282 includes a first section 28A, a second section 28B, a third section 28C, and a fourth section 28D. The first section 28A is connected to the upper pillar portion 261 and is inclined rearward from the upper pillar portion 261. The second section 28B extends from the lower end of the first section 28A. The second section 28B is inclined forward from the lower end of the first section 28A. The third section 28C extends from the lower end of the second section 28B. The third section 28C is inclined further forward from the lower end of the second section 28B. The third section 28C faces the upper wall portion 243 of the connecting frame 24. The fourth section 28D extends downward from the lower end of the third section 28C. The lower end of the fourth section 28D is the lower end 30 of each of the leg portions 281, 282, which is positioned forwardly of the upper pillar portion 261. The lower ends 30 of the pair of leg portions 281, 282 are fixed to the front wall portion 241 of the connecting frame 24.

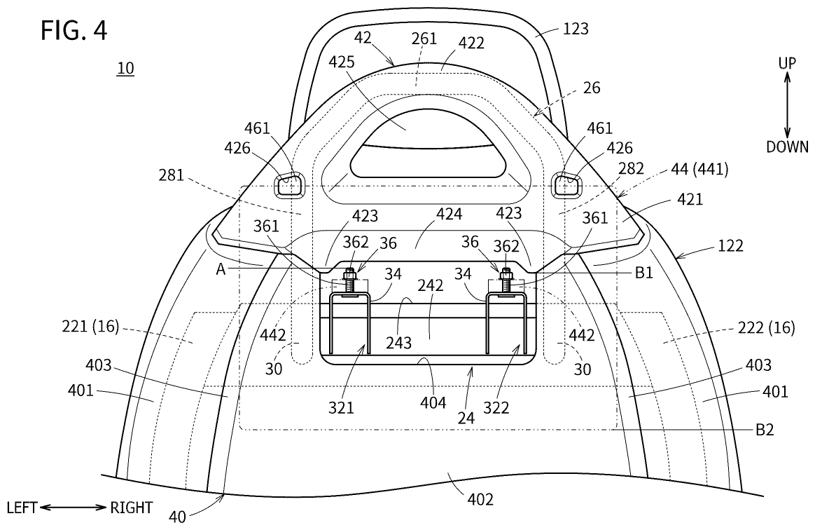

As shown in FIG. 4, the seatback frame 16 is provided with a pair of coupling members 321, 322. Each of the pair of coupling members 321, 322 is fixed to the connecting frame 24. As shown in FIG. 3, the coupling members 321, 322 are fixed to the rear wall portion 242 of the connecting frame 24 by welding or the like, for example. A display device 44, which will be described later, is attached to the pair of coupling members 321, 322. Each of the pair of coupling members 321, 322 includes a mounting bracket 34 and a fastening member 36. The pair of coupling members 321, 322 are disposed apart from each other in the seat width direction (the left-right direction) of vehicle seat 10 (see FIG. 4).

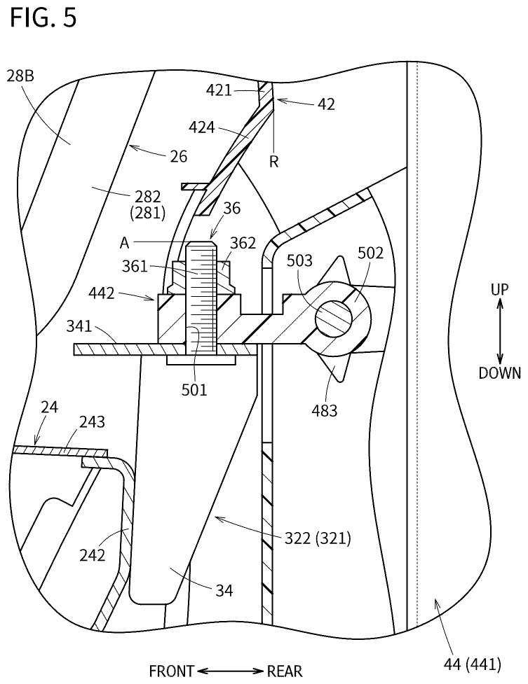

As shown in FIG. 5, a front end portion of each of the mounting brackets 34 is fixed to the rear wall portion 242 of the connecting frame 24 by welding. The upper part of each of the mounting bracket 34 is formed as a mounting surface 341. The mounting surface 341 is a flat surface facing upward and extending along the left-right direction. The mounting surface 341 is positioned above the upper wall portion 243 of the connecting frame 24. The fastening member 36 includes a bolt 361 fixed to the mounting bracket 34 and a nut 362 to be screwed to the bolt 361. The bolt 361 is provided on the upper portion of the mounting bracket 34 and protrudes upward from the mounting surface 341. The protruding direction of the bolt 361 is the vertically upward direction. The fastening member 36 is disposed rearward of the rear wall portion 242 of the connecting frame 24. A coupling portion 442 of the display device 44, which will be described later, is to be placed on the bolt 361. In this case, the uppermost end A (hereinafter also referred to as the upper end A) of the coupling members 321, 322 is the tip ends of the bolts 361.

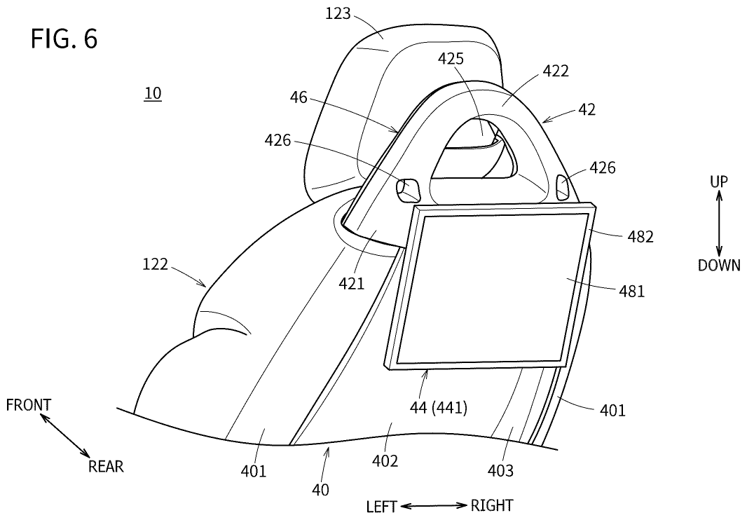

As shown in FIG. 6, the vehicle seat 10 further includes a back cover 40, an upper cover 42 (hereinafter referred to as a cover member 42), and the display device 44. The back cover 40 and the cover member 42 are provided on the rear surface of the vehicle seat 10, and function as a rear surface cover of the vehicle seat 10.

The back cover 40 covers the rear side of the seatback frame 16 (see FIG. 2). As shown in FIG. 4, the back cover 40 includes a pair of side covers 401 and a central cover 402. The pair of side covers 401 respectively cover the pair of frame bodies 221, 222 of the seatback frame 16. The central cover 402 is provided between the pair of side covers 401. The central cover 402 is recessed forward from the pair of side covers 401 (see FIG. 6). As shown in FIG. 4, the central cover 402 has curved sections 403 smoothly connected to the pair of side covers 401, respectively. Each of the curved sections 403 has an arc-shaped cross-section that is convex toward the seatback frame 16. The upper portion of the central cover 402 has an open window 404. The upper portion of the back cover 40 is partially indented downward in a quadrangular shape to form the open window 404 penetrating the back cover 40 in the seat front-rear direction. As shown in FIG. 3, the coupling members 321, 322 are accommodated in the open window 404. The coupling members 321, 322 partially protrudes rearward from the central cover 402 through the open window 404.

The cover member 42 is arranged above the back cover 40 and covers the rear side of the headrest pillar 26. As shown in FIG. 4, the cover member 42 includes a cover body 421, an arch portion 422 over the cover body 421, a pair of protrusions 423, and an inclined portion 424.

The cover body 421 extends in the left-right direction and is connected to an upper portion of the back cover 40. The leg portions 281, 282 of the headrest pillar 26 are partially housed inside the cover body 421. To be specific, the first section 28A and the second section 28B of the leg portions 281, 282 are covered with the cover member 42 (see FIG. 3).

The arch portion 422 is connected to the cover body 421 at both ends thereof in the width direction. When viewed from the rear of vehicle seat 10, the arch portion 422 is formed in a substantially arc shape that gradually extends upward from both ends of the cover body 421 toward the center in the seat width direction. A hole 425 extends through the arch portion 422. The upper pillar portion 261 and parts of the leg portions 281, 282 of the headrest pillar 26 are housed inside the arch portion 422. The arch portion 422 covers the rear of the upper pillar portion 261 and the parts of the leg portions 281, 282.

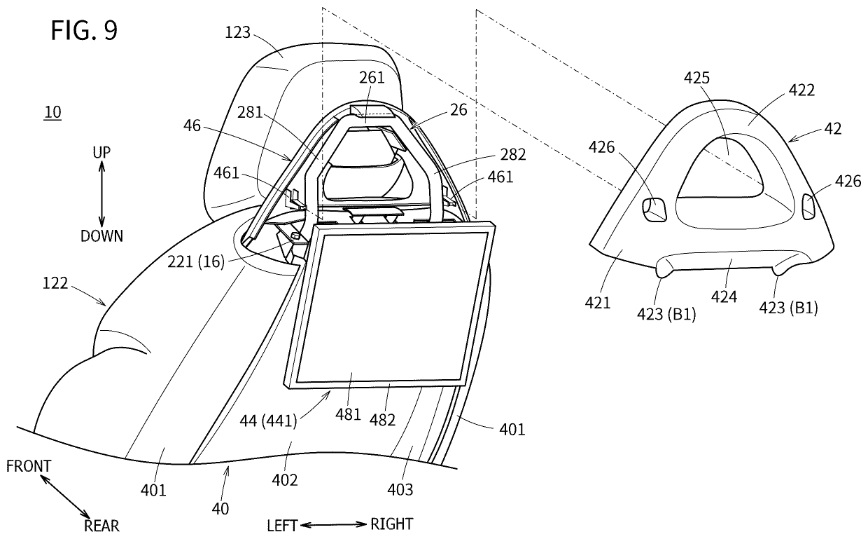

The pair of protrusions 423 are provided at the lower end portion of the cover member 42 (also see FIG. 9). Each of the pair of protrusions 423 protrudes downward from the lower end portion of the cover body 421. The lower end of each protrusion 423 is the lowermost end B1 (hereinafter, also simply referred to as the lower end B1) of the cover member 42. The lower end B1 of the cover member 42 (the protrusion 423) is positioned below the upper end of the bolt 361, which is the upper end A of the coupling members 321, 322. The shape of each of the protrusions 423 is a substantially triangular shape or a substantially trapezoidal shape that tapers downward. The shape of the protrusion 423 may be, for example, a substantially quadrangular shape.

The pair of protrusions 423 are spaced apart from each other in the seat width direction (the left-right direction) of the vehicle seat 10. The inner surface of each protrusion 423 abuts against the upper portion of each curved section 403 of the back cover 40. The inner surface of each protrusion 423 is curved in accordance with the curved shape of the curved section 403. One protrusion 423 of the pair of protrusions 423 abuts against the curved section 403 on one side in the seat width direction. The other protrusion 423 of the pair of protrusions 423 abuts against the curved section 403 on the other side in the seat width direction. The present invention is not limited to the configuration in which the pair of protrusions 423 are provided at the lower end portion of the cover member 42. For example, the cover member 42 may include one protrusion 423 at the lower end portion thereof, or may not include any protrusion 423.

As shown in FIG. 3, the inclined portion 424 is provided at a lower end portion of the cover body 421 of the cover member 42. The inclined portion 424 is inclined downward and forward. That is, the inclined portion 424 is inclined downward in a direction away from the display device 44.

The cover member 42 has a pair of insertion holes 426. Each of the pair of insertion holes 426 is provided at a lower end portion of the arch portion 422. Each insertion hole 426 penetrates the cover member 42 in the front-rear direction. The cover member 42 is attached to a front cover 46 disposed forward of the headrest pillar 26. As shown in FIG. 9, the front cover 46 is disposed rearward of the headrest 123. When the cover member 42 is attached to the front cover 46, a pair of engaging portions 461 of the front cover 46 are inserted into and engaged with the pair of insertion holes 426 of the cover member 42, respectively. The headrest pillar 26 is thereby covered by the front cover 46 and the cover member 42.

As shown in FIG. 6, the display device 44 is provided on the rear surface of the vehicle seat 10. The display device 44 is disposed on the rear side of the back cover 40. The rear surface of the vehicle seat 10 faces another vehicle seat disposed rearward in the unillustrated vehicle. As shown in FIG. 3, a part of the display device 44 and the cover member 42 face each other in the front-rear direction of the vehicle seat 10 (hereinafter also referred to as the seat front-rear direction).

As shown in FIG. 2, the display device 44 includes a monitor unit 441 that can display videos and images, and the coupling portion 442 (see FIG. 3) that is coupled to the seatback frame 16. The monitor unit 441 includes a display 481 and a monitor frame 482. The display 481 is, for example, a sensitive panel display. The panel display is, for example, a liquid crystal panel or an organic EL panel. The display 481 has, for example, a rectangular shape that is long in the left-right direction. The display 481 is electrically connected to a video output device or an image output device of the unillustrated vehicle. The monitor frame 482 has a quadrangular outer shape and surrounds the display 481. The monitor frame 482 holds the display 481.

As shown in FIG. 3, the monitor unit 441 has a predetermined thickness T in the front-rear direction of vehicle seat 10. In the seat front-rear direction of vehicle seat 10, a gap C is formed between the front end of the monitor unit 441 and the rear end R of the cover member 42. The gap C (the size of the gap C) is equal to or larger than the thickness T of the monitor unit 441 in the seat front-rear direction (C≥T).

The coupling portion 442 is arranged forward of the monitor unit 441. The coupling portion 442 extends forward of the front end portion of the monitor unit 441. The coupling portion 442 holds the monitor unit 441 in a rotatable manner. As shown in FIG. 4, a pair of the coupling portions 442 are provided and spaced apart from each other in the seat width direction. The pair of coupling portions 442 are placed on and coupled to the upper surfaces of the mounting brackets 34 of the pair of coupling members 321, 322, respectively. When the vehicle seat 10 is viewed from the rear, the coupling portions 442 are positioned between the pair of protrusions 423 of the cover member 42. That is, the coupling portions 442 are positioned on the inner side in the seat width direction with respect to the pair of protrusions 423. As shown in FIG. 3, the cover member 42 is located above the coupling portions 442. Therefore, when the vehicle seat 10 is viewed from above, at least a part of the coupling portions 442 are covered with the cover member 42.

As shown in FIG. 4, the lower end B1 of the cover member 42 is positioned above the lower end B2 of the display device 44. The lower end B2 of the display device 44 is the lower end of the monitor unit 441.

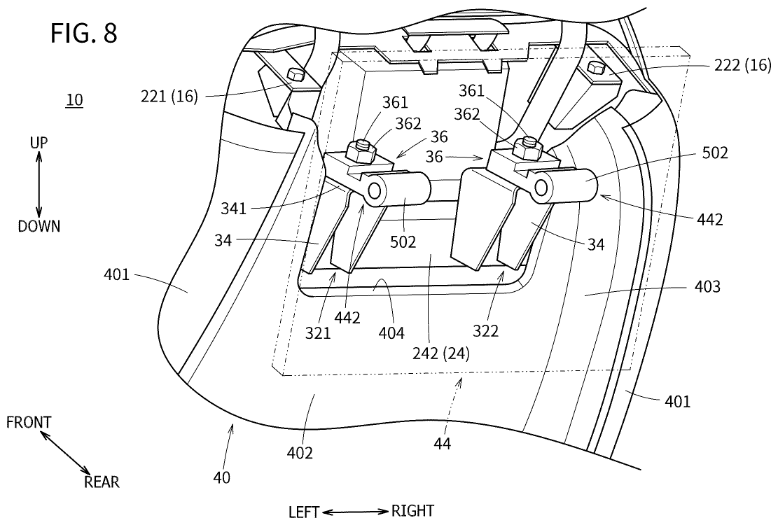

As shown in FIG. 5, each of the coupling portions 442 has a through hole 501 penetrating in the up-down direction. In a state where the coupling portions 442 abut against the upper surfaces of the mounting brackets 34, respectively, the bolts 361 of the coupling members 321, 322 are inserted into the through holes 501, and the nuts 362 are screwed to the bolts 361. The pair of coupling portions 442 are held between the mounting brackets 34 and the nuts 362 that constitute the coupling members 321, 322 (see also FIG. 8). The monitor unit 441 of the display device 44 is coupled to the coupling members 321, 322 and the seatback frame 16 by the coupling portions 442. The upper ends A of the coupling members 321, 322 (the upper ends of the bolts 361) are positioned above the coupling portions 442. The upper ends A of the coupling members 321, 322 may be positioned below the coupling portions 442, or the upper ends A of the coupling members 321, 322 and the coupling portions 442 may be positioned at the same height.

In the seat front-rear direction of the vehicle seat 10, the front end of each coupling portion 442 is arranged forward of the rear end R of the cover member 42. In other words, the rear end R of the cover member 42 is disposed rearward of each of the coupling portions 442.

The rear ends of the coupling portions 442 have pivot shaft portions 502. Support shafts 503 extending in the seat width direction are inserted into the pivot shaft portions 502. The pivot shaft portions 502 are supported by the support shafts 503. The pivot shaft portions 502 are supported by the supports 483 of the monitor unit 441. The monitor unit 441 is rotatable by a predetermined angle about the pivot shaft portions 502 and the support shafts 503. As shown in FIG. 3, the rear end R of the cover member 42 is disposed rearward of the coupling portions 442 in the seat front-rear direction of the vehicle seat 10. The rear end R of the cover member 42 is the upper end of the inclined portion 424.

As shown in FIG. 2, in the seat-width direction of the vehicle seat 10, the length L1 of the monitor unit 441 is smaller than the length L2 of the cover member 42 (L1<L2). That is, the length L2 of the cover member 42 is greater than the length L1 of the monitor unit 441 (L2>L1). The length L2 of the cover member 42 represents the length of the cover body 421. When viewed from the rear of the vehicle seat 10, the cover member 42 protrudes in the left-right direction from both ends of the monitor unit 441 in the seat width direction. The length L2 of the cover member 42 is not limited to the case where the length L2 of the cover member 42 is greater than the length L1 of the monitor unit 441. For example, the length L2 of the cover member 42 may be smaller than the length L1 of the monitor unit 441, or the length L2 of the cover member 42 may be the same as the length L1 of the monitor unit 441.

Next, a method of assembling the display device 44 to the vehicle seat 10 will be described.

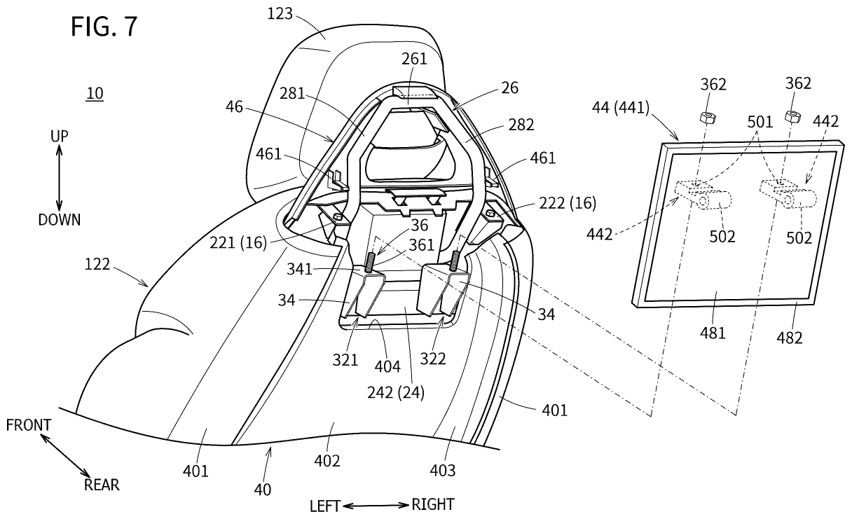

As shown in FIG. 7, the display device 44 is attached to the coupling members 321, 322 in a state in which the rear side of the seatback frame 16 and the headrest pillar 26 is open.

Specifically, the coupling portions 442 of the display device 44 are disposed forward of the monitor unit 441, and the bolts 361 of the coupling members 321, 322 are inserted into the through holes 501 of the pair of coupling portions 442. In this case, the bolts 361 are inserted into the through holes 501 from below the through holes 501. As a result, as shown in FIG. 8, the lower surfaces of the coupling portions 442 are brought into contact with the mounting surfaces 341 of the mounting brackets 34. Accordingly, the pair of coupling portions 442 are held on the upper surfaces of the pair of mounting brackets 34, and the monitor unit 441 is held substantially horizontally by the coupling members 321, 322 (see FIG. 5). Next, the nuts 362 are screwed onto the bolts 361 from the upper ends of the bolts 361 and tightened so that the coupling portions 442 are sandwiched between the nuts 362 and the mounting brackets 34. As a result, as shown in FIG. 9, the display device 44 is fixed to the rear of the seatback frame 16 via the pair of coupling members 321, 322.

Next, the cover member 42 is attached so as to cover the rear of the headrest pillar 26. Specifically, as shown in FIG. 9, the cover body 421 is inserted between the monitor unit 441 of the display device 44 and the headrest pillar 26 in a state in which the arch portion 422 of the cover member 42 is directed upward. Then, as shown in FIG. 4, the coupling portion 442 is disposed between the pair of protrusions 423, and the inner surfaces of the pair of protrusions 423 are brought into contact with the curved sections 403 of the back cover 40. The cover member 42 is thereby positioned in the seat width direction with respect to the back cover 40 and the seatback frame 16. At this time, the lower end B1 of the cover body 421 and the upper ends A of the coupling members 321, 322 are spaced from each other in the vertical direction, and the lower end B1 at each of the protrusions 423 is disposed below the upper ends (upper ends A) of the bolts 361 of the coupling members 321, 322. The lower end B1 of the cover member 42 may be disposed above the upper ends A of the coupling members 321, 322. The lower end B1 of the cover member 42 and the upper ends A of the coupling members 321, 322 may be at the same level.

Next, in a state in which the rear of the headrest pillar 26 is covered by the cover member 42, the cover member 42 is engaged with the engaging portion 461 (see FIG. 9) of the front cover 46. The cover member 42 is thereby attached to the rear of the headrest pillar 26. In the foregoing manner, as shown in FIG. 6, the assembly of the display device 44 to the rear surface of the vehicle seat 10 is completed.

As shown in FIG. 3, in the display device 44 assembled as described above, the inclined portion 424 of the cover member 42 and the front end of the monitor unit 441 are separated from each other in the seat front-rear direction. As shown in FIG. 4, the lower end B1 of the cover member 42 is disposed above the lower end B2 of the monitor unit 441 in the display device 44. When viewed from the rear of the vehicle seat 10, the lower end B1 of the cover member 42, the coupling portions 442, coupling members 321, 322, and the open window 404 are covered with the monitor unit 441 of the display device 44. Therefore, the lower end B1 of the cover member 42, the coupling portions 442, and the coupling members 321, 322 are visually hidden by the monitor unit 441 from the occupant seated on the rear seat.

The present embodiment exhibits the following advantageous effects.

As shown in FIG. 3, the vehicle seat 10 includes the seatback frame 16, the coupling portions 442 coupled to the seatback frame 16, the display device 44 having the monitor unit 441 capable of displaying an image, and the cover member 42 disposed to cover the coupling portions 442. The lower end B1 of the cover member 42 is positioned above the lower end B2 of the display device 44.

According to this configuration, since the cover member 42 is provided above the lower end B2 of the display device 44, it is possible to effectively suppress an increase in the size of the cover member 42.

The gap C is formed between the display device 44 and the cover member 42 in the seat front-rear direction of the vehicle seat 10. The gap C is equal to or larger than the thickness T of the monitor unit 441 in the seat front-rear direction.

According to this configuration, since the gap C of a predetermined size or more is provided between the display device 44 and the cover member 42, the cover member 42 can be easily assembled after the display device 44 is attached to the seatback frame 16. The gap C is not limited to the case where the gap C is equal to or larger than the thickness T of the monitor unit 441. For example, the gap C may be equal to or less than the thickness T of the monitor unit 441.

As shown in FIG. 2, in the seat-width direction of the vehicle seat 10, the length L2 of the cover member 42 is greater than the length L1 of the monitor unit 441.

According to this configuration, the visibility of the cover member 42 when the cover member 42 is attached can be improved, and the assembly workability of the cover member 42 can be effectively improved.

As shown in FIG. 4, the coupling portions 442 and the seatback frame 16 are coupled to each other by the coupling members 321, 322. The upper ends A of the coupling members 321, 322 are disposed above the coupling portions 442. The lower end B1 of the cover member 42 is positioned below the upper ends A of the coupling members 321, 322.

According to this configuration, when the cover member 42 is attached to the seatback frame 16 to cover the coupling portions 442, the coupling members 321, 322 and the coupling portions 442 can be effectively covered and visually hidden by the cover member 42. Therefore, the appearance of the rear surface of the vehicle seat 10 can be improved.

The lower end portion of the cover member 42 includes a pair of protrusions 423 that are separated from each other in the seat width direction and protrude downward. The coupling portions 442 are disposed between the pair of protrusions 423.

According to this configuration, when the cover member 42 is attached to the seatback frame 16, the positioning of the cover member 42 is facilitated.

As shown in FIG. 3, in the seat front-rear direction of the vehicle seat 10, the rear end R of the cover member 42 is positioned rearward of the coupling portions 442.

According to this configuration, since the rear end R of the cover member 42 is positioned rearward of the coupling portions 442, the coupling portions 442 can be effectively covered and visually hidden by the cover member 42. Therefore, the appearance of the rear surface of the vehicle seat 10 can be improved.

As shown in FIG. 3, the lower end portion of the cover member 42 has the inclined portion 424 that is inclined downward in the direction away from the monitor unit 441. The present invention is not limited to the configuration in which the inclined portion 424 is provided at the lower end portion of the cover member 42. For example, the lower end portion of the cover member 42 may be formed so as to extend downward without being inclined.

According to this configuration, when the cover member 42 is assembled to the seatback frame 16 in a state in which the display device 44 is attached to the seatback frame 16, interference between the lower end portion of the cover member 42 and the monitor unit 441 of the display device 44 can be effectively suppressed by the inclined portion 424.

In relation to the above-described disclosure, the following supplementary notes are further disclosed.

### Supplementary Note 1

The vehicle seat (10) includes: the seatback frame (16); the display device (44) including the coupling portion (442) to be coupled to the seatback frame and the monitor unit (441) configured to display an image; and the cover member (42) arranged to cover the coupling portion, wherein the lower end (B1) of the cover member is arranged above the lower end (B2) of the display device.

According to this configuration, since the cover member is provided above the lower end of the display device, it is possible to effectively suppress an increase in the size of the cover member.

### Supplementary Note 2

In the vehicle seat according to Supplementary Note 1, the gap (C) may be formed between the display device and the cover member in a front-rear direction of the vehicle seat, and the gap may be equal to or larger than the thickness (T) of the monitor unit in the front-rear direction. According to this configuration, since the gap of a predetermined size or more is provided between the display device and the cover member, the cover member can be easily assembled after the display device is attached to the seatback frame.

### Supplementary Note 3

In the vehicle seat according to Supplementary Note 1 or 2, the length (L2) of the cover member may be greater than the length (L1) of the monitor unit in the width direction of the vehicle seat. According to this configuration, the visibility of the cover member when the cover member is being attached can be improved, and the assembly workability of the cover member can be effectively improved.

### Supplementary Note 4

In the vehicle seat according to any one of Supplementary Notes 1 to 3, the coupling portion and the seatback frame may be coupled to each other by the coupling member (321, 322), the upper end (A) of the coupling member may be arranged above the coupling portion, and the lower end of the cover member may be arranged below the upper end of the coupling member. According to this configuration, when the cover member is to be attached to the seatback frame to cover the coupling portions, the coupling members and the coupling portions can be effectively covered and visually hidden by the cover member. Therefore, the appearance of the rear surface of the vehicle seat can be improved.

### Supplementary Note 5

In the vehicle seat according to any one of Supplementary Notes 1 to 4, the lower end portion of the cover member may include the pair of protrusions (423) that are separated from each other in the width direction of the vehicle seat and protrude downward, and the coupling portion may be arranged between the pair of protrusions. According to this configuration, when the cover member is being attached to the seatback frame, the positioning of the cover member is facilitated.

### Supplementary Note 6

In the vehicle seat according to any one of Supplementary Notes 1 to 5, the rear end (R) of the cover member may be positioned rearward of the coupling portion in the front-rear direction of the vehicle seat. According to this configuration, since the rear end of the cover member is disposed rearward of the coupling portions, the coupling portions can be effectively covered and visually hidden by the cover member. Therefore, the appearance of the rear surface of the vehicle seat can be improved.

### Supplementary Note 7

In the vehicle seat according to any one of Supplementary Notes 1 to 6, the lower end portion of the cover member may include the inclined portion (424) that is inclined downward in the direction away from the monitor unit. According to this configuration, when the cover member is being assembled to the seatback frame in a state in which the display device is attached to the seatback frame, interference between the lower end portion of the cover member and the monitor unit of the display device can be effectively suppressed by the inclined portion.

It should be noted that the present disclosure is not limited to the disclosure described above, and various additional or alternative configurations could be adopted therein without departing from the essence and gist of the present disclosure.

1. A vehicle seat comprising:
a seatback frame;
a display device including a coupling portion to be coupled to the seatback frame and a monitor unit configured to display an image; and
a cover member arranged to cover the coupling portion, wherein
a lower end of the cover member is arranged above a lower end of the display device.

2. The vehicle seat according to claim 1, wherein
a gap is formed between the display device and the cover member in a front-rear direction of the vehicle seat, and
the gap is equal to or larger than a thickness of the monitor unit in the front-rear direction of the vehicle seat.

3. The vehicle seat according to claim 1, wherein a length of the cover member is greater than a length of the monitor unit in a width direction of the vehicle seat.

4. The vehicle seat according to claim 1, wherein
the coupling portion and the seatback frame are coupled to each other by a coupling member,
an upper end of the coupling member is arranged above the coupling portion, and
the lower end of the cover member is arranged below the upper end of the coupling member.

5. The vehicle seat according to claim 4, wherein
a lower end portion of the cover member includes a pair of protrusions that are separated from each other in a width direction of the vehicle seat and protrude downward, and
the coupling portion is arranged between the pair of protrusions.

6. The vehicle seat according to claim 1, wherein a rear end of the cover member is positioned rearward of the coupling portion in a front-rear direction of the vehicle seat.

7. The vehicle seat according to claim 1, wherein a lower end portion of the cover member includes an inclined portion that is inclined downward in a direction away from the monitor unit.
